(19) United States
(12) Patent Application Publication
(10) Pub. No.: US 2026/0313680 A1
(43) Pub. Date: Oct. 8, 2026

(54) METHOD AND APPARATUS FOR CONFIGURATION AND REPORTING IN A WIRELESS COMMUNICATION SYSTEM

(71) Applicant: Samsung Electronics Co., Ltd., Suwon-si, Gyeonggi-do (KR)

(72) Inventors: Xingyu HAN, Beijing (CN); Hong WANG, Beijing (CN)

(21) Appl. No.: 19/482,093

(22) PCT Filed: Jul. 18, 2024
(86) PCT No.: PCT/KR2024/010366

§ 371 Date: Nov. 6, 2025

(30) Foreign Application Priority Data
Aug. 2, 2023 (CN) 202310969474.6

(51) Int. Cl. H04W 72/566; H04W 72/25; H04W 72/542

(52) U.S. Cl. CPC H04W 72/566; H04W 72/25; H04W 72/542

(57) ABSTRACT

The present disclosure provides a method in a wireless communication system and an apparatus thereof. In one embodiment, there is provided a method performed by a first node in a wireless communication system, the method comprising: receiving twelfth information from a base station, the twelfth information comprising information related to an identity of a second node and priority related information; and based on the received priority related information, performing corresponding scheduling or resource allocation on the second node.

### TECHNICAL FIELD

The present application relates to wireless communication technology, and in particular to a method and apparatus for measurement configuration and/or reporting of quality-of-experience.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Currently, there are needs to enhance configuration and reporting in a wireless communication system.

### Solution to Problem

According According to one aspect of the present disclosure, there is provided a method performed by a first node in a wireless communication system, the method including: receiving twelfth information from a base station, the twelfth information including information related to an identity of a second node and priority related information; and based on the received priority related information, performing corresponding scheduling or resource allocation on the second node.

In a further embodiment, the priority related information comprises at least one of: indication or suggested/recommended indication related to prioritized scheduling or prioritized allocation of resources; indication or suggested/recommended indication related to low-priority/de-prioritized scheduled or low-priority/de-prioritized allocated resources; and priority.

In a further embodiment, the method further comprises transmitting first configuration-related information to a second node, the first configuration-related information being related to sidelink-related Quality of Experience measurement, wherein the first configuration-related information comprises at least one of: service type information related to proximity service (ProSe) or vehicle-to-everything (V2X) service; configuration information related to Quality of Experience measurement or application layer measurement; information related to configuration identity for Quality of Experience measurement or application layer measurement; and a resource allocation mode.

In further embodiments, information related to the Quality of Experience measurement configuration or application layer measurement configuration comprises at least one of: a Quality of Experience reference; area scope related information or location filter related information; a measurement collection entity address; a slice list or slice identity; a reporting interval or reporting period/periodicity; and measurement time-related information.

In further embodiments, the area scope related information or location filter related information comprises at least one of: a cell identity or a cell list; a tracking area code (TAC) or tracking area list; a tracking area identity or a list of tracking area identities/IDs; and a public land mobile network (PLMN) identity or PLMN list.

In further embodiments, the measurement time related information comprises at least one of: measurement start time; measurement end time; measurement duration; and a measurement time window.

In further embodiments, the method further comprises: transmitting fifth information to the base station, wherein the fifth information comprises information related to an identity of the user equipment; wherein the information related to the identity of the user equipment comprises at least one of: information for indicating the first node or the second node; information related to an identity of the first node; and information related to an identity of the second node.

In further embodiments, the information related to the identity of the first node comprises at least one of: a sidelink source identity/ID or a list of sidelink source identities/IDs; and an application layer group identity/ID or a list of the group identities/IDs.

In further embodiments, the information related to the identity of the second node comprises at least one of: a sidelink destination identity/ID or a list of destination identities/IDs; and an application layer group identity/ID or a list of the group identities/IDs.

In further embodiments, the method further comprises receiving seventh information from the base station, the seventh information comprising at least one of: service type information related to the ProSe or V2X service; a request for Quality of Experience measurement configuration or a request for application layer measurement configuration; information related to suggested/recommended configuration for Quality of Experience measurement or suggested/recommended configuration for application layer measurement; parameter(s) related to Quality of Experience measurement or application layer measurement; a configuration identity for Quality of Experience measurement, application layer measurement or list of those configuration identities/IDs; information related to an identity of the second node; and a resource allocation mode.

In further embodiments, the seventh information is transmitted by the base station based on thirteenth information it receives, wherein the thirteenth information comprises at least one of: service type information related to ProSe or V2X service; and authorization information related to Quality of Experience for the ProSe or V2X service.

In further embodiments, the authorization information related to Quality of Experience for the ProSe or V2X service comprises at least one of functions: authorizing the user equipment to use Quality of Experience-related functions; authorizing the user equipment to use Quality of Experience-related functions as a transmitting user equipment/TX UE; and authorizing the user equipment to use the Quality of Experience-related function as a receiving user equipment/RX UE.

In a further embodiment, the method further comprises receiving first report related information from a second node, the first report related information comprising a sidelink-related Quality of Experience measurement report; transmitting second report related information to the base station through a radio resource control (RRC) message or a medium access control (MAC) control unit.

In further embodiments, the twelfth information is transmitted by the base station based on the second report related information.

In accordance with another aspect of the present disclosure, there is provided a first node in a wireless communication system, comprising: a transceiver configured to transmit and receive a signal; and a processor coupled to the transceiver and configured to perform the method described above as performed by the first node. Wherein the first node may be a user equipment.

In accordance with another aspect of the present disclosure, there is provided a second node in a wireless communication system, comprising: a transceiver configured to transmit and receive a signal; and a processor coupled to the transceiver and configured to perform operations compatible with the above-described method performed by the first node. Wherein the second node may be a user equipment.

According to another aspect of the present disclosure, there is provided a method performed by a third node in a wireless communication network, the method comprising: receiving second report related information from the first node or the second node; and transmitting twelfth information to the first node, the twelfth information including information related to the identity of the second node and priority related information.

In a further embodiment, the priority related information comprises at least one of: an indication or suggested/recommended indication related to prioritized scheduling or prioritized allocation of resources; an indication or suggested/recommended indication related to low-priority/de-prioritized scheduling or low-priority/de-prioritized allocation resource; and priority.

In further embodiments, the method further comprises: receiving fifth information from the first node or the second node, wherein the fifth information comprises information related to an identity of the user equipment; wherein the information related to the identity of the user equipment comprises at least one of: information for indicating the first node or the second node; information related to the identity of the first node; information related to the identity of the second node.

In further embodiments, the information related to the identity of the first node comprises at least one of: a sidelink source identity/ID or a list of sidelink source identities/IDs; and an application layer group identity/ID or a list of the group identities/IDs.

In further embodiments, the information related to the identity of the second node comprises at least one of: a sidelink destination identity/ID or a list of destination identities/IDs; and an application layer group identity/ID or a list of the group identities/IDs.

In further embodiments, the method further comprises: transmitting seventh information to the first node or the second node, the seventh information comprising at least one of: service type information related to the ProSe or V2X service; a request for Quality of Experience measurement configuration or a request for application layer measurement configuration; information related to suggested/recommended configuration for Quality of Experience measurement or suggested/recommended configuration for application layer measurement; parameter(s) related to Quality of Experience measurement or application layer measurement; a configuration identity for Quality of Experience measurement, application layer measurement or list of those configuration identities/IDs; information related to the identity of the second node; and a resource allocation mode.

In a further embodiment, the method further comprises receiving thirteenth information from a fifth node, the thirteenth information comprising at least one of: service type information related to the ProSe or V2X service; and authorization information related to Quality of Experience for the ProSe or V2X service.

In further embodiments, the authorization information related to Quality of Experience for the ProSe or V2X service comprises at least one of functions: authorizing the user equipment to use Quality of Experience-related functions; authorizing the user equipment to use Quality of Experience-related functions as a transmitting user equipment/TX UE; and authorizing the user equipment to use the Quality of Experience-related function as a receiving user equipment/RX UE.

In further embodiments, the method further comprises receiving seventh configuration-related information from the first node or the second node, the seventh configuration-related information comprising at least one of: service type information related to the ProSe or V2X service; configuration information related to Quality of Experience measurement or application layer measurement; information related to configuration identity for Quality of Experience measurement or application layer measurement; information related to the identity of the first node; and a resource allocation mode.

In a further embodiment, when the seventh configuration-related information is received from the second node, the seventh configuration-related information is transmitted by the second node based on the first configuration-related information received from the first node.

In accordance with another aspect of the present disclosure, there is provided a third node in a wireless communication system, which includes a transceiver configured to transmit and receive a signal; and a processor coupled with the transceiver and configured to perform the method performed by the third node as described above. Wherein the third node may be a base station, or a centralized unit of a base station, or a control plane part of a centralized unit of a base station.

According to another aspect of the disclosure, there is provided a method performed by a fourth node in a wireless communication network, the method comprising: receiving Quality of Experience information from a third node; and transmitting twelfth information to the first node, the twelfth information including information related to the identity of the second node and priority related information.

In a further embodiment, the priority related information comprises at least one of: an indication or suggested/recommended indication related to prioritized scheduling or prioritized allocation of resources; an indication or suggested/recommended indication related to low-priority/de-prioritized scheduling or low-priority/de-prioritized allocation resource; and priority.

In a further embodiment, the method further comprises receiving eighth configuration-related information from a third node, wherein the eighth configuration-related information includes at least one of: service type information related to proximity traffic or V2X service; a request for Quality of Experience measurement configuration or a request for application layer measurement configuration; information related to suggested/recommended configuration for Quality of Experience measurement or suggested/recommended configuration for application layer measurement; parameter(s) related to Quality of Experience measurement or application layer measurement; a configuration identity of Quality of Experience measurement or application layer measurement; and transmitting information related to an identity of the user equipment; and transmitting ninth configuration-related information to the third node, wherein the ninth configuration-related information includes at least one of: configuration or configuration related information for Quality of Experience measurement or application layer measurement; a configuration identity of Quality of Experience measurement or application layer measurement; and receiving information related to the identity of the user equipment.

In accordance with another aspect of the present disclosure, there is provided a fourth node in a wireless communication system, which includes: a transceiver configured to transmit and receive a signal; and a processor coupled with the transceiver and configured to perform the method performed by the fourth node as described above. Wherein the fourth node may be a distributed unit of the base station.

In accordance with another aspect of the present disclosure, there is provided a fifth node in a wireless communication system, which includes: a transceiver configured to transmit and receive a signal; and a processor coupled with the transceiver and configured to transmit thirteenth information to a second node and perform operations in the methods mentioned above, the thirteenth information comprising at least one of: service type information related to the ProSe or V2X service; and authorization information related to Quality of Experience for the ProSe or V2X service. Wherein the fifth node may be a core network device, for example, an Access and Mobility Management Function (AMF), or an Operation Administration and Maintenance (OAM) entity.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 is an example of an example system architecture;

FIG. 2 is an example of a base station structure;

FIG. 3A is an example embodiment of measurement configuration and/or reporting for sidelink.

FIG. 3B is an example embodiment of measurement configuration and/or reporting for sidelink.

FIG. 3C is an example embodiment of measurement configuration and/or reporting for sidelink.

FIG. 3D is an example embodiment of measurement configuration and/or reporting for sidelink.

FIG. 3E is an example embodiment of measurement configuration and/or reporting for sidelink.

FIG. 3F is an example embodiment of measurement configuration and/or reporting for sidelink.

FIG. 3G is an example embodiment of measurement configuration and/or reporting for sidelink.

FIG. 3H is an example embodiment of measurement configuration and/or reporting for sidelink.

FIG. 3I is an example embodiment of measurement configuration and/or reporting for sidelink.

FIG. 3J is an example embodiment of measurement configuration and/or reporting for sidelink.

FIG. 3K is an example embodiment of measurement configuration and/or reporting for sidelink.

FIG. 4 is a block diagram of a user equipment (UE) in a wireless communication system according to an embodiment of the present disclosure; and

FIG. 5 is a block diagram of a network node in a wireless communication system according to the present disclosure.

### BEST MODE FOR CARRYING OUT THE INVENTION

To meet the demand for wireless data communication traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

Wireless communication is one of the most successful innovations in modern history. Recently, the number of subscribers to wireless communication services exceeds 5 billion and continues to grow rapidly. Due to the increasing popularity of smartphones and other mobile data devices (e.g., tablet computers, notebook computers, netbooks, e-book readers, and machine type devices) among consumers and businesses, the demand for wireless data traffic is rapidly growing. To meet the high growth of mobile data traffic and support new applications and deployments, improving wireless interface efficiency and coverage is crucial.

With the gradual maturation of 5G commercial networks (NR: New Radio access network), the application range of QoE (Quality of Experience) technology is also continuously expanding, and corresponding research and standardization efforts have been developed in order to better improve user experience.

In order to make the objectives, technical schemes and advantages of the embodiments of the present disclosure, a clearly and complete description will be made with respect to the technical schemes of the embodiments of the present disclosure, in conjunction with the accompanying drawings of the embodiments of the present disclosure. Apparently, the described embodiments are a part of the embodiments of the present disclosure, not all of the embodiments. Based on the described embodiments of the present disclosure, all other embodiments obtained by ordinary skilled in the art without creative labor belong to the protection scope of the present disclosure.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect to or with, contain, be included within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The function associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. For example, “at least one of A, B, or C” includes any of the following combinations: A, B, C, A and B, A and C, B and C, and A and B and C.

In addition, various functions described below can be implemented or supported by one or more computer programs, each of which is formed by computer-readable program code and embodied in a computer-readable medium. The terms “application” and “program” refer to one or more computer programs, software components, instruction sets, procedures, functions, objects, classes, instances, related data or parts thereof appropriate for implementation in suitable computer-readable program code. The phrase “computer readable program code” includes any type of computer code, including source code, objective code and executable code. The phrase “computer readable medium” includes any type of medium that can be accessed by a computer, such as Read-Only Memory (ROM), Random Access Memory (RAM), hard disk drive, compact disk (CD), digital video disk (DVD) or any other type of memory. A “non-transitory” computer-readable medium excludes wired, wireless, optical or other communication links that transfer transitory electrical or other signals. A non-transitory computer-readable medium includes a medium in which data can be stored permanently and a medium in which data can be stored and rewritten later, such as rewritable optical disks or erasable memory devices.

The terms used herein to describe the embodiments of the present application is not intended to limit and/or define the scope of the present application. For example, unless otherwise defined, the technical or scientific terms used in the present disclosure should have ordinary meanings as understood by ordinary skilled in the art to which the present application belongs.

It should be understood that “first”, “second” and similar words used in the present disclosure do not indicate any order, quantity or importance, but are only used to distinguish different components. Unless clearly indicated otherwise in the context, similar words such as “a”, “an”, “the” and the like in the singular form do not indicate a quantitative limitation, but indicate the existence of at least one.

As used herein, any reference to “one example” or “an example”, “one embodiment” or “an embodiment” means that a particular element, feature, structure or characteristic described in conjunction with the embodiment is included in at least one embodiment. The appearances of the phrases “in one embodiment” or “in one example” in different places in the specification are not necessarily all referring to the same embodiment.

As used herein, “a part of” a certain thing means “at least some of” this thing, so it may mean being less than the entirety thereof or being the entirety thereof. Therefore, “a part of” the thing includes the whole thing as a special case, that is, an example in which the whole thing is a part of the thing.

It will be further understood that words such as “include”, “contain” or the like means that the elements or objects appearing preceding the word encompass the elements or objects listed behind the word as well as their equivalents, without excluding other elements or objects. Words such as “connect”, “interconnect” or the like are not limited to physical or mechanical connections, but may include electrical connection, whether direct or indirect. “Up”, “Down”, “Left” and “Right” are only used to indicate relative positional relationships. When the absolute position of the described object changes, accordingly, the relative positional relationship may change as well.

The various embodiments discussed below for describing the principle of the present disclosure in this patent document are for illustration only, and should not be construed as limiting the scope of the present disclosure in any way. Those skilled in the art will understand that the principle of the present disclosure may be implemented in any suitably arranged wireless communication system. For example, although the following detailed description of the embodiments of the present disclosure will focus on LTE and 5G communication systems, those skilled in the art can understand that the main points of the present disclosure can also be applied to other communication systems with similar technical backgrounds and channel formats, with slight modifications and basically without departing from the scope of the present disclosure. The schemes of the embodiments of the present application may be applied to various communication systems. For example, the communication systems may include a Global System for Mobile communications (GSM) system, a Code Division Multiple Access (CDMA) system, a Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunication System (UMTS), worldwide interoperability for microwave access (WiMAX) communication system, fifth generation (5th generation, 5G) system or New Radio (NR), etc. In addition, the schemes of the embodiments of the present application may be applied to future-oriented communication technologies.

The following description with reference to the accompanying drawings is provided to assist in a comprehensive understanding of various embodiments of the present disclosure as defined by the claims and their equivalents. The description includes various specific details to assist in that understanding but should be regarded as exemplary only. Accordingly, the ordinary skilled in the art will recognize that various changes and modifications to the various embodiments described herein can be made without departing from the scope and spirit of the present disclosure. In addition, descriptions of well-known functions and structures may be omitted for clarity and conciseness.

The terms and wordings used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only, but not for the purpose of limiting the present disclosure as defined by the appended claims and their equivalents.

It should be understood that the singular forms “a,” “an,” and “the” include plural referents, unless clearly indicated otherwise in the context. Thus, for example, reference to “a component surface” includes reference to one or more of such surfaces.

The term “include” or “may include” refers to the existence of a corresponding disclosed function, operation or component which can be used in various embodiments of the present disclosure, and does not limit the existence of one or more additional functions, operations, or components. The terms “include” and/or “have” may be construed to represent certain characteristics, numbers, steps, operations, constituent elements, components or combinations thereof, but may not be construed to exclude the possibility of existence of one or more other characteristics, numbers, steps, operations, constituent elements, components or combinations thereof.

The term “or” used in various embodiments of the present disclosure includes any of the listed terms or all combinations thereof. For example, “A or B” may include A, may include B, or may include both A and B.

Unless defined differently, all terms used in the present disclosure, including technical or scientific terms, have the same meanings as those understood by the skilled in the art as described in the present disclosure. Common terms as defined in a dictionary are to be interpreted to have meanings consistent with the context in the relevant technical field, and are not to be interpreted ideally or excessively, unless clearly defined as such in the present disclosure.

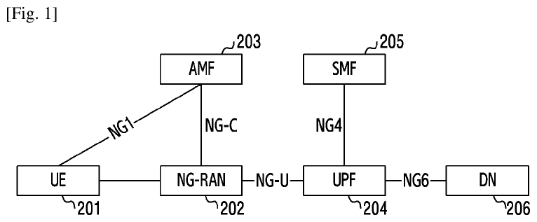

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is an exemplary system architecture 200 according to various embodiments of the present disclosure. Other embodiments of the system architecture 200 could be used without departing from the scope of the present disclosure. The user equipment (UE) 201 is a terminal device to receive data. The Next Generation Radio Access Network (NG-RAN) 202 is a radio access network that includes a base station (gNB or eNB connected to the 5G core network 5GC, eNB connected to 5GC also called ng-gNB) that provides an access wireless network interface for a UE. The Access Control and Mobility Management Function (AMF) 203 is responsible for managing the mobility context of the UE, and security information. The user plane functional entity (UPF) 204 mainly provides the functions of the user plane. The session management function SMF 205 is responsible for session management. The data network (DN) 206 includes services such as operators, access to the Internet, and traffic for third parties, among others.

In the NR system, in order to support network function virtualization, more efficient resource management and scheduling, a base station (gNB/ng-eNB) providing a wireless network interface for a terminal (UE) may be further divided into a centralized unit gNB-CU/ng-eNB-CU (gNB central unit/ng-eNB central unit) and a distributed unit gNB-DU/ng-eNB-DU (gNB distributed unit/ng-eNB distributed unit) (simply referred to as CU and DU in the present disclosure), as shown in FIG. 2 (a).

The gNB-CU has Radio Resource Control (RRC), Service Data Adaptation Protocol (SDAP) and Packet Data Convergence Protocol (PDCP) protocol layers, etc., and the ng-eNB-CU has an RRC layer and a PDCP layer. The gNB-DU/ng-eNB-DU has Radio Link Control Protocol (RLC), Medium Access Control (MAC), and Physical layers, among others. The interface between gNB-CU and gNB-DU is a standardized public interface F1 and between ng-eNB-CU and ng-eNB-DU is a standardized public interface W1. The F1 interface includes the control plane F1-C and the user plane F1-U. The transport network layer of F1-C is based on IP transport. For more reliable transport signaling, the SCTP protocol was added on top of IP. The protocol of the application layer is F1AP (F1 interface application protocol), see 3GPP TS 38. 473. SCTP may provide reliable application layer message transmission. The transport layer of F1-U is UDP/IP and GTP-U is used on top of UDP/IP for carrying user plane protocol data units, i.e., PDUs. Further, for a gNB-CU, as shown in FIG. 2 (b), the gNB-CU may include a gNB-CU-CP (control plane part of the centralized unit of the base station) containing the control plane functions of the base station with RRC and PDCP protocol layers and a gNB-CU-UP (user plane part of the centralized unit of the base station) containing the user plane functions of the base station with SDAP and PDCP protocol layers. The interface between gNB-CU-CP and gNB-CU-UP is a standardized public interface El and the protocol is E1AP, see 3GPP TS 38. 463. The interface between the control plane part of the centralized unit of the base station and the distributed unit of the base station is the F1-C interface, i.e. the control plane interface of F1, and the interface between the user plane part of the centralized unit of the base station and the distributed unit of the base station is the F1-U interface, i.e. the user plane interface of F1. In addition, in the NR system, a base station providing the E-UTRA user plane and control plane accessing the 5G core network is called ng-eNB, and in order to support virtualization, such a base station (ng-eNB) may also be further divided into a centralized unit ng-eNB-CU (gNB central unit/ng-eNB central unit) and a distributed unit ng-eNB-DU (gNB distributed unit/ng-eNB distributed unit) (simply referred to as CU and DU in the present disclosure), as shown in FIG. 2 (c). The ng-eNB-CU has an RRC, PDCP layer. The gNB-DU/ng-eNB-DU has Radio Link Control Protocol (RLC), Medium Access Control (MAC), and Physical layers, among others. The interface between the ng-eNB-CU and the ng-eNB-DU is a standardized public interface W1. The W1 interface includes the control plane W1-C and the user plane W1-U. The transport network layer of W1-C is based on IP transport. For more reliable transport signaling, the SCTP protocol was added on top of IP. The protocol at the application layer is W1AP, see 3GPP TS37. 473. The transport layer of W1-U is UDP/IP and GTP-U is used on top of UDP/IP for carrying user plane protocol data units, i.e., PDUs.

Currently, with respect to Quality of Experience (QoE), the study focus are mainly on the configuration and reporting of Quality of Experience (QoE) measurements of the radio interface (or Uu interface, i.e., the interface between the terminal and the access network), and how to configure and/or report measurements for the sidelink is not studied yet. The present disclosure relates generally to measurement configuration and/or reporting for sidelink. In various embodiments of the present disclosure, various methods and apparatus for measurement configuration and/or reporting of sidelink related QoE are provided.

The exemplary embodiments of the present disclosure are further described below in conjunction with the accompanying drawings.

The text and figures are provided by way of example only to assist in understanding the present disclosure. They are not to be construed as limiting the scope of the disclosure in any way. Although certain embodiments and examples have been provided, it will be apparent to those of skill in the art, based upon the disclosure herein, that changes can be made to the embodiments and examples shown without departing from the scope of the disclosure.

Before introducing details, some assumptions and some definitions of the present disclosure are given below.
The message names in this disclosure are examples only, and other message names may be used.
“First,” “second,” and the like included in the message names of the present disclosure are merely examples of messages, and do not represent an order of execution
A detailed explanation of steps unrelated to the present disclosure is omitted from the present disclosure.
In the present disclosure, the steps in each flow may be performed in combination with each other or may be performed separately. The execution steps of each flow are merely examples and do not exclude other possible execution orders.
In the present disclosure, the base station may be a 5G base station (e.g., gNB, ng-eNB), a 4G base station (e.g., eNB), a 6G base station, or other types of access nodes.
In the present disclosure, transmission of data refers to receiving or transmitting of data.

The nodes to which this disclosure relates includes:
First node: first user equipment (UE)
Second Node: Second User Equipment
Third node: a base station, or a centralized unit of a base station, or a control plane part of a centralized unit of a base station
Fourth node: Distribution unit of base station
Fifth node: Core network device, e.g., Access and Mobility Management Function (AMF), or Operation Administration and Maintenance (OAM) entity

The measurement configuration and/or reporting scheme of the sidelink of the present disclosure includes various implementation as follows. In the present context, “Quality of Experience measurement” is used interchangeably with “application layer measurement”.

The present disclosure provides a method for measurement configuration and/or reporting of sidelink quality-of-experience that, by way of inter-node interaction/coordination, guarantees that sidelink user equipments can make more flexible resource allocations based on quality-of-experience measurement, thereby improving users' quality-of-experience.

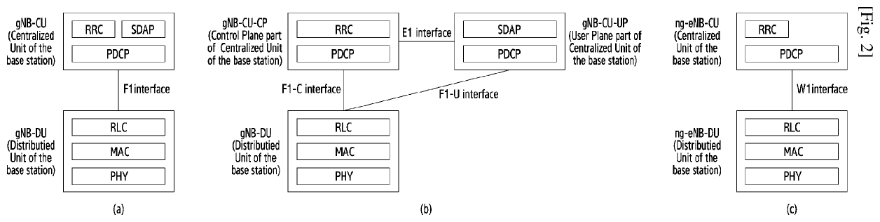

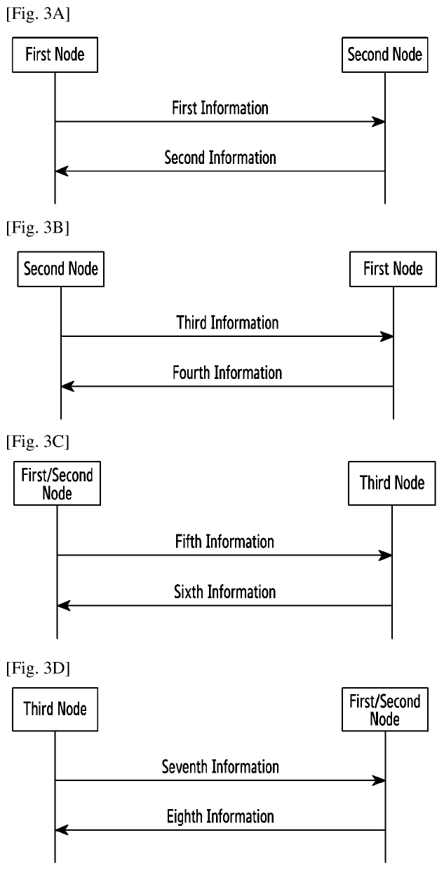

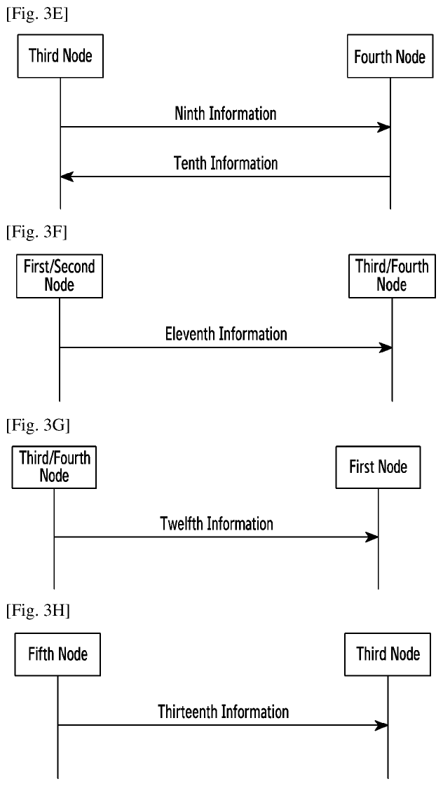

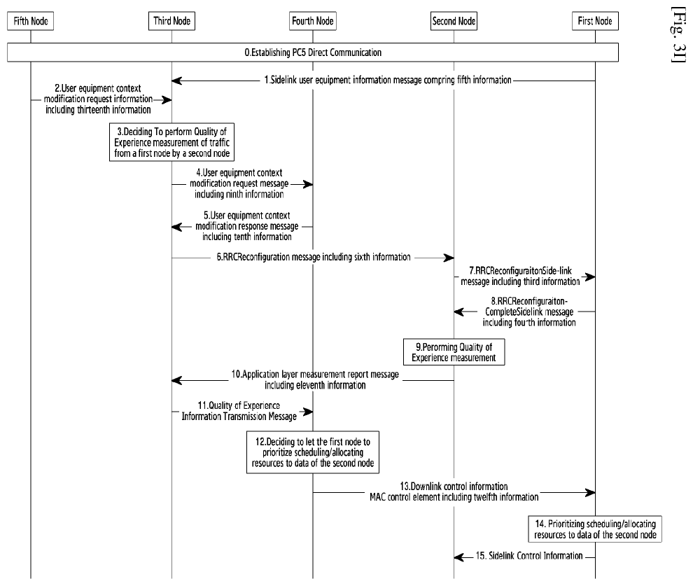

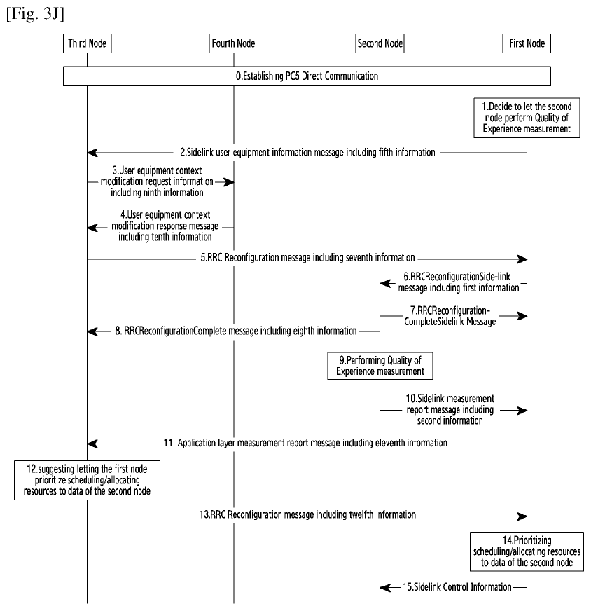

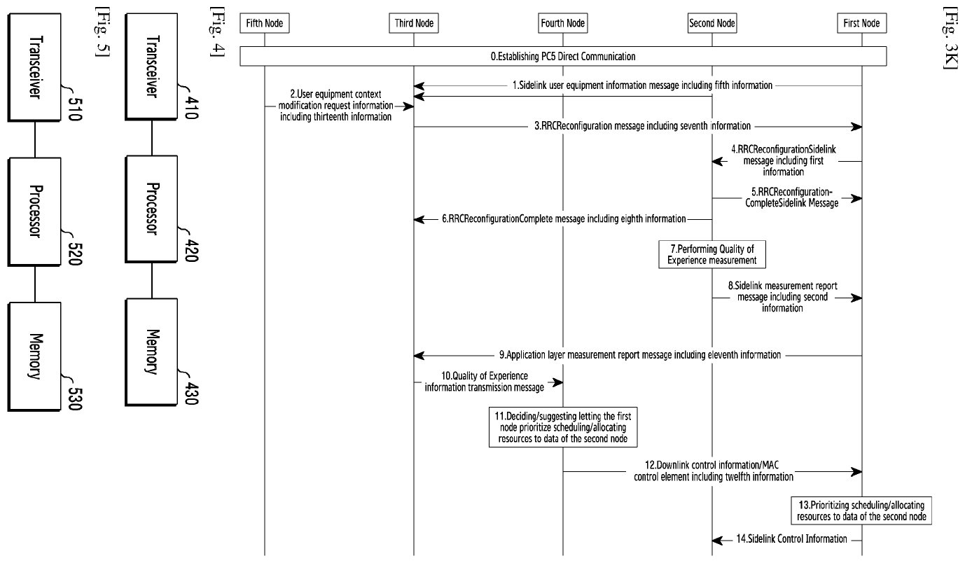

FIG. 3A illustrates an example method for measurement configuration and/or reporting of sidelink-related quality-of-experience according to one embodiment of the present disclosure. As illustrated in FIG. 3A, a first node transmits first information related to measurement configuration of sidelink-related Quality of Experience to a second node, wherein the first information includes first configuration information for the sidelink-related Quality of Experience measurement.

Wherein the first configuration information for the sidelink-related Quality of Experience measurement comprises at least one of:
Service type information related to Proximity Service (ProSe) or Vehicle-to-Everything (V2X) service
Configuration for Quality of Experience Measurement or Application Layer Measurement
Configuration identity for Quality of Experience Measurement or Application Layer Measurement
Configuration identity for Sidelink Quality of Experience measurement or sidelink application layer measurement
Configuration identity for Quality of Experience measurement of PC5 interface or application layer measurement of the PC5 interface
Information related to an identity of a transmitting user equipment/TX UE
Information related to an identity of a receiving user equipment/RX UE
Resource allocation mode(s)

Wherein the configuration for Quality of Experience measurement or the application layer measurement includes, but is not limited to, at least one of the following information:
Quality of Experience reference or Quality of Experience reference identity
Area scope related information or location filter related information
Address of a measurement collection entity
Slice list or slice identity
Reporting interval or reporting period/periodicity
Measurement time-related information

Wherein the area scope related information or location filter related information includes at least one of:
Cell identity or cell list
Tracking Area Code (TAC) or Tracking Area List
Tracking Area Identity or Tracking Area Identity list
PLMN (Public Land Mobile Network) identity or PLMN list

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Application layer group identity/ID list
Cell Radio Network Temporary Identity or other Radio Network Temporary Identity
Cell Radio Network Temporary Identity list or other Radio Network Temporary Identity list

Exemplarily, wherein the information related to the identity of the receiving user equipment/RX UE comprises at least one of:
Sidelink destination identity/ID
Sidelink destination identity/ID list
Application layer group identity/ID
Application layer group identity/ID list

The first information may be included in the RRCReconfigurationSidelink message or in other PC5-RRC messages.

The second node, upon receiving the first information, performs Quality of Experience measurement configuration or an application layer measurement configuration according to the content of the first information. The first node may provide one or more Quality of Experience measurement configuration to the second node, each of which may be uniquely identified/acknowledged/confirmed by a measurement identity or reference identity in the first information, wherein the measurement identity may comprise at least one of: a configuration identity for Quality of Experience measurement or application layer measurement, a configuration identity for sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The second node determines whether the first information is transmitted to the second node based on the information related to the identity of the receiving user equipment/RX UE. The second node decides to which nodes to transmit the Quality of Experience measurement report according to the resource allocation mode. One possible implementation is that if the resource allocation mode is indicated as resource allocation mode one, the second node may take either of the following ways: 1. the second node transmits the Quality of Experience measurement report to the first node; 2. the second node transmits the Quality of Experience measurement report to the third node; and 3. the second node transmits the Quality of Experience measurement report to the first node, and the first node forwards the received Quality of Experience measurement report to the third node; if the resource allocation mode is indicated as resource allocation mode two, the second node transmits the Quality of Experience measurement report to the first node. Wherein the Quality of Experience measurement report comprise sidelink-related Quality of Experience measurement(s).

By the way in which the first node directly configures the second node with Quality of Experience measurement as described above, the first node can more flexibly trigger/initiate Quality of Experience measurement configuration as needed, enabling the second node to make more timely Quality of Experience measurement and/or reporting, thereby ensuring that the first node and/or the third node can make more flexible resource allocations based on Quality of Experience measurement, thereby improving the Quality of Experience of the user.

The second node, after performing Quality of Experience measurement or the application layer measurement based on the received first information, transmits to the first node second information for reporting the sidelink-related Quality of Experience measurement, wherein the second information includes first report related information for the sidelink-related Quality of Experience measurement.

Wherein the first report related information of the sidelink-related Quality of Experience measurement comprises at least one of:
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Sidelink destination identity/ID
Quality of Experience measurement result(s) or Quality of Experience measurement report(s)

The second information may be included in the MeasurementReportSidelink message or in other PC5-RRC messages.

The first node, upon reception of the second information by, performs resource allocation or scheduling to the second node based on the content of the second information. The first node determines the Quality of Experience measurement configuration for which the second information is subject to according to the measurement configuration identity (i.e. at least one of the Quality of Experience measurement configuration identity or the application layer measurement configuration identity, the sidelink Quality of Experience measurement configuration identity or the sidelink application layer measurement configuration identity), the configuration identity for Quality of Experience measurement of PC5 interface or application layer measurement of the PC5 interface. The first node identifies the second node according to the sidelink destination identity/ID.

By the manner in which the second node reports the Quality of Experience measurement directly to the first node as described above, it is ensured that the first node can correctly identify the Quality of Experience measurement report and make a more flexible allocation of resources based on the Quality of Experience measurement report, thereby improving the Quality of Experience of the user.

FIG. 3B illustrates an example method for measurement configuration and/or reporting of sidelink-related quality-of-experience, according to another embodiment of the present disclosure. As shown in FIG. 3B, the second node transmits third information related to measurement configuration of the sidelink-related Quality of Experiencet to the first node, wherein the third information includes second configuration-related information for the sidelink-related Quality of Experience measurement.

Wherein the second configuration-related information of the sidelink-related Quality of Experience measurement comprises at least one of:
Service type information related to Proximity Service (ProSe) or V2X (Vehicle-to-Everything) traffic
Information related to Quality of Experience measurement configuration or application layer measurement configuration
A request for Quality of Experience measurement configuration or a request for application layer measurement configuration
Information related to suggested/recommended configuration for Quality of Experience measurement or suggested/recommended configuration for application layer measurement
Parameter(s) related to Quality of Experience measurement or application layer measurement
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface

It should be noted that, in a specific embodiment, the specific content of the second configuration-related information depends on whether the second node decides to perform configuration for Quality of Experience measurement: if the second node decides to perform configuration for Quality of Experience measurement, at least information related to Quality of Experience configuration or application layer measurement configuration is included in the second configuration-related information; if it is not the second node that decides on (e.g. the second node is only involved in) the configuration for Quality of Experience measurement, at least one of the following is included in the second configuration-related information: a request for Quality of Experience measurement configuration or a request for the application layer measurement configuration, the information related to suggested/recommended configuration for Quality of Experience measurement or suggested/recommended configuration for application layer measurement, the parameter(s) related to Quality of Experience measurement or the application layer measurement.

Wherein the Quality of Experience measurement configuration-related information or the application layer measurement configuration-related information or the information related to suggested/recommended Quality of Experience measurement configuration or suggested/recommended application layer measurement configuration at least includes, but is not limited to, one of the following:
Quality of Experience reference or Quality of Experience reference identity
Area scope related information or location filter related information
Address of a measurement collection entity
Slice list or slice identity
Reporting interval or reporting period/periodicity
Measurement time-related information

Wherein the area scope related information or location filter related information includes at least one of:
Cell identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

The third information may be included in the RRCReconfigurationSidelink message or in other PC5-RRC messages.

The first node, after receiving the third information, according to the content of the third information, performs Quality of Experience measurement configuration acknowledgement/confirm or application layer measurement configuration acknowledgement/confirm and transmits a message comprising Quality of Experience measurement configuration acknowledgement/confirm or configuration complete information or application layer measurement configuration acknowledgementt/confirm or configuration complete information to the second node, or provides Quality of Experience measurement configuration or application layer measurement configuration and transmits Quality of Experience measurement configuration or application layer measurement configuration to the second node. The second node may provide one or more Quality of Experience measurement configuration or measurement configuration requests to the first node, each of which may be uniquely identified/acknowledged/confirmed by a measurement identity or reference identity in the third information, wherein the measurement identity may comprise at least one of: a configuration identity for Quality of Experience measurement or application layer measurement, a configuration identity for sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity.

In the manner described above in which the second node provides a request for the Quality of Experience measurement configuration or measurement configuration directly to the first node, it is guaranteed that the first node can obtain the Quality of Experience measurement configuration in time and obtain the Quality of Experience measurement report according to the configuration-related information (if the second node decides on the Quality of Experience measurement configuration), or that the first node can perform the Quality of Experience measurement configuration on the second node in time according to the request of the second node (if it is not the second node which decides on the Quality of Experience measurement configuration), it is guaranteed that the second node performs Quality of Experience measurement and/or reporting more timely, thereby it is guaranteed that the first node and/or the third node can make a more flexible allocation of resources based on the Quality of Experience measurement, thereby improving the Quality of Experience of the user.

The first node, after receiving the third information, transmits, to the second node, fourth information related to measurement configuration of the sidelink-related Quality of Experience according to the content of the third information, wherein the fourth information includes third configuration-related information for the sidelink-related Quality of Experience measurement.

Wherein the third configuration-related information of the sidelink-related Quality of Experience measurement comprises at least one of the following:
Service type information related to Proximity Service (ProSe) or V2X (Vehicle-to-Everything) traffic
Quality of experience measurement configuration acknowledgement/confirm or application layer measurement configuration acknowledgement/confirm
Quality of Experience measurement configuration or application layer measurement configuration
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Information related to an identity of the transmitting user equipment/TX UE
Information related to an identity of the receiving user equipment/RX UE
Resource allocation mode(s)

Wherein the Quality of Experience measurement configuration or the application layer measurement configuration includes, but is not limited to, at least one of the following information:
Quality of Experience reference or Quality of Experience reference Identity
Area scope Related information or location filter related information
Address of measurement collection entity
Slice list or slice identity
Reporting interval or reporting period/periodicity
Measurement time-related information

Wherein the area scope related information or location filter related information includes at least one of:
Cell Identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Application layer group identity/ID list
Cell Radio Network Temporary Identity or other Radio Network Temporary Identity
Cell Radio Network Temporary Identity list or other Radio Network Temporary Identity list

Wherein the information related to the identity of the receiving user equipment/RX UE comprises at least one of:
Sidelink destination identity/ID
Sidelink destination identity/ID list
Application layer group identity/ID
Application layer group identity/ID list

The fourth information may be included in the RRC reconfiguration complete Sidelink message or in other PC5-RRC messages.

The second node, after receiving the fourth information, performs Quality of Experience measurement configuration and/or performs Quality of Experience measurement according to the content of the fourth information. The first node may provide one or more Quality of Experience measurement configuration to the second node, each of which may be uniquely identified/acknowledged/confirmed by a measurement identity or reference identity in the fourth information, wherein the measurement identity may comprise at least one of: a configuration identity for Quality of Experience measurement or application layer measurement, a configuration identity for sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The second node determines whether the fourth information is transmitted to the second node based on the information related to the identity of the receiving user equipment/RX UE. The second node decides to which nodes to transmit the Quality of Experience measurement report according to the resource allocation mode. One possible implementation is that if the resource allocation mode is indicated as resource allocation mode one, the second node may take either of the following ways: 1. the second node transmits the Quality of Experience measurement report to the first node; 2. the second node transmits the Quality of Experience measurement report to the third node; and 3. the second node transmits the Quality of Experience measurement report to the first node, and the first node forwards the received Quality of Experience measurement report to the third node; if the resource allocation mode is indicated as resource allocation mode two, the second node transmits the Quality of Experience measurement report to the first node.

By the manner of the first node providing the Quality of Experience measurement configuration according to the request of the second node as described above, the second node is guaranteed to make more timely Quality of Experience measurement and/or reporting, thereby ensuring that the first node and/or the third node can make more flexible resource allocation based on the Quality of Experience measurement, thereby improving the Quality of Experience of the user.

FIG. 3C illustrates an example method for measurement configuration and/or reporting of sidelink-related quality-of-experience, according to another embodiment of the present disclosure. As shown in FIG. 3C, the first node or the second node transmits fifth information to the third node for providing the sidelink user equipment related information, wherein the fifth information includes at least one of the following information:
Information related to the identity of the user equipment
Fourth configuration-related information of sidelink-related Quality of Experience measurement

Wherein the information related to the identity of the user equipment comprises at least one of:
Information indicating a transmitting user equipment/TX UE or a receiving user equipment/RX UE, e.g. the information may be an indication information that the user equipment is a transmitting user equipment/TX UE or a receiving user equipment/RX UE
Information related to an identity of the transmitting user equipment/TX UE
Information related to an identity of the transmitting user equipment/TX UE in communication with the receiving user equipment/RX UE
Information related to an identity of the receiving user equipment/RX UE
Information related to an identity of the receiving user equipment/RX UE in communication with a transmitting user equipment/TX UE

Wherein the information related to the identity of the transmitting user equipment/TX UE or the information related to the identity of the transmitting user equipment/TX UE in communication with the receiving user equipment/RX UE comprises at least one of:
Sidelink source identity/ID
Sidelink source identity/ID list
Application layer group identity/ID
Application layer group identity/ID list

Wherein the information related to the identity of the receiving user equipment/RX UE or the information related to the identity of the receiving user equipment/RX UE in communication with the transmitting user equipment/TX UE comprises at least one of:
Sidelink destination identity/ID
Sidelink destination identity/ID list
Application layer group identity/ID
Application layer group identity/ID list

Wherein the fourth configuration-related information of the sidelink-related Quality of Experience measurement comprises at least one of the following:
Service type information related to Proximity Service (ProSe) or V2X (Vehicle-to-Everything) traffic
Information related to Quality of Experience measurement configuration or application layer measurement configuration
A request for Quality of Experience measurement configuration or a request for application layer measurement configuration
Information related to suggested/recommended configuration for Quality of Experience measurement or suggested/recommended configuration for application layer measurement
Parameter(s) related to Quality of Experience measurement or application layer measurement
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Resource allocation mode

Please be noted that the content of the fourth configuration-related information depends on whether the first node or the second node decides to perform configuration for Quality of Experience measurement: if the first node or the second node decides to perform configuration for Quality of Experience measurement, at least configuration information related to Quality of Experience measurement or application layer measurement may be included in the fourth configuration-related information; if it is not the first node or the second node that decides to do (e.g., the first node or the second node in only involved in) the Quality of Experience measurement configuration, at least one of the following may be included in the fourth configuration-related information: a request for Quality of Experience measurement configuration or a request for application layer measurement configuration, information related to suggested/recommended configuration for Quality of Experience measurement or suggested/recommended configuration for application layer measurement, parameter(s) related to Quality of Experience measurement or application layer measurement.

Wherein the Quality of Experience measurement configuration or the application layer measurement configuration or the suggested/recommended Quality of Experience measurement configuration or the suggested/recommended application layer measurement configuration at least includes, but is not limited to, one of the following information:
Quality of Experience reference or Quality of Experience reference identity
Area scope related information or location filter related information
Address of a measurement collection entity
Slice list or slice identity
Reporting interval or reporting period/periodicity
Measurement time-related information

Wherein the area scope related information or location filter related information includes at least one of:
Cell identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

The fifth information may be included in the SidelinkUEInformationNR message or in other RRC messages.

The third node, after receiving the fifth information, according to the content of the fifth information, performs Quality of Experience measurement configuration acknowledgement/confirm or application layer measurement configuration acknowledgement/confirm and transmits a message including the Quality of Experience measurement configuration acknowledgement/confirm or application layer measurement configuration acknowledgement/confirm information to the first node or the second node, or provides the Quality of Experience measurement configuration or application layer measurement configuration and transmits the Quality of Experience measurement configuration or application layer measurement configuration to the first node or the second node. The first node or the second node may provide one or more Quality of Experience (or application layer) measurement configurations or measurement configuration requests to the third node, each of which may be uniquely identified/acknowledged/confirmed by a measurement identity or reference identity in the fifth information, wherein the measurement identity may comprise at least one of: a configuration identity for Quality of Experience measurement or application layer measurement, a configuration identity for sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The third node identifies the user equipment participating in or requesting to participate in sidelink-related Quality of Experience measurement, or transmitting user equipment/TX UE and receiving user equipment/RX UE according to the information related to the identity of the user equipment.

By providing the sidelink user equipment-related information to the third node by the first node or the second node as described above, it is guaranteed that the third node can obtain the request for Quality of Experience measurement configuration or Quality of Experience measurement configuration in a timely manner so that the third node can provide the Quality of Experience measurement configuration or acknowledge/confirm the Quality of Experience measurement configuration in a timely manner so as to receive the Quality of Experience measurement report(s) more timely, it is guaranteed that the third node can make more flexible resource allocation based on the Quality of Experience measurement report(s) so as to improve the Quality of Experience of the user.

On the other hand, in the manner described above, it is guaranteed that the third node can timely identify user equipment that participates or requests to participate in sidelink-related Quality of Experience measurement, thereby guaranteeing that the third node can select a more reasonable way of resource allocation and/or provide a more reasonable allocation of sidelink-related resources to the transmitting user equipment/TX UE and the receiving user equipment/RX UE.

The third node, after receiving the fifth information, transmits sixth information related to measurement configuration of sidelink-related Quality of Experience to the first node or the second node according to the content of the fifth information, wherein the sixth information includes fifth configuration-related information for the sidelink-related Quality of Experience measurement.

Wherein the fifth configuration-related information of the sidelink-related Quality of Experience measurement comprises at least one of the following:
Service type information related to Proximity Service (ProSe) or V2X (Vehicle-to-Everything) traffic
Quality of experience measurement configuration acknowledgement/confirm or application layer measurement configuration acknowledgement/confirm
Quality of Experience measurement configuration or application layer measurement configuration
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Information related to an identity of the transmitting user equipment/TX UE
Information related to an identity of the receiving user equipment/RX UE
Resource allocation mode(s)

Wherein the Quality of Experience measurement configuration or the application layer measurement configuration includes, but is not limited to, at least one of the following information:
Quality of Experience reference or Quality of Experience reference identity
Area scope related information or location filter related information
Measurement collection entity address
Slice list or slice identity
Reporting interval or reporting period/periodicity
Measurement time-related information

Wherein the area scope related information or location filter related information includes at least one of:
Cell identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Application layer group identity/ID list

Wherein the information related to the identity of the receiving user equipment/RX UE comprises at least one of:
Sidelink destination identity/ID
Sidelink destination identity/ID list
Application layer group identity/ID
Application layer group identity/ID list

The sixth information may be included in the RRC Reconfiguration (RRCReconfiguration) message, may be included in the SL-PreconfigurationNR information, or may be included in other RRC messages.

The first node or the second node, after receiving the sixth information, performs Quality of Experience measurement configuration and/or Quality of Experience measurement based on the content of the sixth information. The third node may provide one or more Quality of Experience measurement configuration to the first node or the second node, each of which may be uniquely identified/acknowledged/ confirmed by a measurement identity or a reference identity in the sixth information, wherein the measurement identity may comprise at least one of: a configuration identity of Quality of Experience measurement or application layer measurement, a configuration identity of sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The first node or the second node identifies the transmitting user equipment/TX UE and receiving user equipment/RX UE participating in Quality of Experience measurement according to the information related to the identity of the user equipment. The second node decides to which nodes to transmit the Quality of Experience measurement report according to the resource allocation mode. One possible implementation is that if the resource allocation mode is indicated as resource allocation mode one, the second node may take either of the following ways: 1. the second node transmits the Quality of Experience measurement report to the first node; 2. the second node transmits the Quality of Experience measurement report to the third node; and 3. the second node transmits the Quality of Experience measurement report to the first node, and the first node forwards the received Quality of Experience measurement report to the third node; if the resource allocation mode is indicated as resource allocation mode two, the second node transmits the Quality of Experience measurement report to the first node.

By the way the third node provides the Quality of Experience measurement configuration or measurement configuration acknowledgement/confirm to the first node or the second node as described above, it is guaranteed that the third node can participate in the negotiation/coordination of the Quality of Experience measurement configuration and that the third node can select a more reasonable way of resource allocation and/or provide a more reasonable sidelink-related resource configuration.

FIG. 3D illustrates an example method for measurement configuration and/or reporting of sidelink-related quality-of-experience, according to another embodiment of the present disclosure. As shown in FIG. 3D, the third node transmits seventh information related to measurement configuration of the sidelink-related Quality of Experience to the first node or the second node, wherein the seventh information includes sixth configuration-related information for the sidelink-related Quality of Experience measurement.

Wherein the sixth configuration-related information of the sidelink-related Quality of Experience measurement comprises at least one of the following:
Service type information related to Proximity Service (ProSe) or V2X (Vehicle-to-Everything) traffic
A request for Quality of Experience measurement configuration or a request for application layer measurement configuration
Information related to suggested/recommended configuration for Quality of Experience measurement or suggested/recommended configuration for application layer measurement
Parameter(s) related to Quality of Experience measurement or application layer measurement
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Quality of Experience measurement configuration identity list or application layer measurement configuration identity list
Configuration identity list for sidelink Quality of Experience measurement or sidelink application layer measurement
Configuration identity list for Quality of Experience measurement of PC5 interface or application layer measurement of the PC5 interface
Information related to an identity of the transmitting user equipment/TX UE
Information related to an identity of the receiving user equipment/RX UE
Resource allocation mode(s)

Wherein the suggested/recommended configuration for Quality of Experience measurement or the suggested/recommended configuration for application layer measurement includes, but is not limited to, at least one of the following information:
Quality of Experience reference or Quality of Experience reference identity
Area scope related information or location filter related information
Measurement collection entity address
Slice list or slice identity
Reporting interval or reporting period/periodicity
Measurement time-related information

Wherein the area scope related information or location filter related information includes at least one of:
Cell identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Application layer group identity/ID list

Wherein the information related to the identity of the receiving user equipment/RX UE comprises at least one of:
Sidelink destination identity/ID
Sidelink destination identity/ID list
Application layer group identity/ID
Application layer group identity/ID list

The seventh information may be included in the RRCReconfiguration message, may be included in the SL-PreconfigurationNR information, or may be included in other RRC messages.

The first node or the second node, upon receiving the seventh information, performs Quality of Experience measurement configuration based on the content of the seventh information. The third node may provide one or more request for Quality of Experience measurement configuration to the first node or the second node, each of which may be uniquely identified/acknowledged/confirmed by a measurement identity or a reference identity in the seventh information, wherein the measurement identity may comprise at least one of: a configuration identity of Quality of Experience measurement or application layer measurement, a configuration identity of sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The first node or the second node identifies transmitting user equipment/TX UE and receiving user equipment/RX UE participating in Quality of Experience measurement according to the information related to the identity of the user equipment. The second node decides to which nodes to transmit the Quality of Experience measurement report according to the resource allocation mode. One possible implementation is that if the resource allocation mode is indicated as resource allocation mode one, the second node may take either of the following ways: 1. the second node transmits the Quality of Experience measurement report to the first node; 2. the second node transmits the Quality of Experience measurement report to the third node; and 3. the second node transmits the Quality of Experience measurement report to the first node, and the first node forwards the received Quality of Experience measurement report to the third node; if the resource allocation mode is indicated as resource allocation mode two, the second node transmits the Quality of Experience measurement report to the first node.

By the manner of the third node providing the a request for Quality of Experience measurement configuration to the first node or the second node as described above, the first node and the second node are guaranteed to be able to negotiate/coordinate the Quality of Experience measurement configuration in a timely manner, thereby guaranteeing a more timely Quality of Experience measurement and/or reporting by the second node, and thus guaranteeing a more flexible allocation of resources by the first node and/or the third node based on the Quality of Experience measurement and improving the Quality of Experience of the user.

The first node or the second node, after receiving the seventh information from the third node, transmits, to the third node, eighth information related to measurement configuration of the sidelink-related Quality of Experience according to the content of the seventh information, wherein the eighth information includes seventh configuration-related information for the sidelink-related Quality of Experience measurement. When the eighth information is transmitted by the second node, the seventh configuration-related information is transmitted by the second node based on the first configuration-related information received from the first node (as described in FIG. 3A).

It is noted that a possible implementation is that the first node or the second node transmits the eighth information to the third node when the resource allocation mode in the seventh message is indicated as resource allocation mode one.

Wherein the seventh configuration-related information of the sidelink-related Quality of Experience measurement comprises at least one of the following:
Service type information related to Proximity Service (ProSe) or V2X (Vehicle-to-Everything) traffic
Quality of Experience measurement configuration or application layer measurement configuration
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Information related to the identity of the transmitting user equipment/TX UE
Information related to the identity of the receiving user equipment/RX UE
Resource allocation mode(s)

Wherein the Quality of Experience measurement configuration or the application layer measurement configuration includes, but is not limited to, at least one of the following information:
Quality of Experience reference or Quality of Experience reference identity
Area scope related information or location filter related information
Address of a measurement collection entity
Slice list or slice identity
Reporting interval or reporting period/periodicity
Measurement time-related information

Wherein the area scope related information or location filter related information includes at least one of:
Cell identity or Cell List
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Application layer group identity/ID list

Wherein the information related to the identity of the receiving user equipment/RX UE comprises at least one of:
Sidelink destination identity/ID
Sidelink destination identity/ID list
Application layer group identity/ID
Application layer group identity/ID list

The eighth information may be included in the RRCReconfigurationComplete message or in other RRC messages.

The third node, after receiving the eighth information, receives a Quality of Experience measurement report from the first node or the second node according to the content of the eighth information. The first node or the second node may provide one or more Quality of Experience measurement configuration to the third node, each of which may be uniquely identified/acknowledged/confirmed by a measurement identity or a reference identity in the eighth information, wherein the measurement identity may comprise at least one of: a configuration identity of Quality of Experience measurement or application layer measurement, a configuration identity of sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The first node or the second node may provide information related to an identity of the user equipment to the third node, which identifies the user equipment or the transmitting user equipment/TX UE and the receiving user equipment/RX UE participating in the sidelink-related Quality of Experience measurement, according to information related to the identity of the user equipment.

By providing the Quality of Experience measurement configuration by the first node or the second node according to the request of the third node as described above, it is guaranteed that the third node can make a more flexible allocation of resources based on the Quality of Experience measurement, thereby improving the Quality of Experience of the user.

On the other hand, in the manner described above, it is guaranteed that the third node can timely identify the user equipment participating in the sidelink-related Quality of Experience measurement, thereby guaranteeing that the third node can make a more reasonable allocation of resources based on the Quality of Experience measurement, thereby improving the Quality of Experience of the user.

FIG. 3E illustrates an example method for measurement configuration and/or reporting of sidelink-related quality-of-experience, according to another embodiment of the present disclosure. As illustrated in FIG. 3E, the third node transmits, to the fourth node, ninth information related to measurement configuration of the sidelink-related Quality of Experience, wherein the ninth information includes eighth configuration-related information for the sidelink-related Quality of Experience measurement.

Wherein the eighth configuration-related information of the sidelink-related Quality of Experience measurement comprises at least one of the following:
Service type information related to Proximity Service (ProSe) or V2X (Vehicle-to-Everything) traffic
A request for Quality of Experience measurement configuration or a request for application layer measurement configuration
Information related to suggested/recommended configuration for Quality of Experience measurement or suggested/recommended configuration for application layer measurement
Information related to Quality of Experience measurement configuration or application layer measurement configuration
Parameter(s) related to Quality of Experience measurement or application layer measurement
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Information related to the identity of the transmitting user equipment/TX UE
Information related to the identity of the receiving user equipment/RX UE
Resource allocation mode(s)

Please be noted that the content of the eighth configuration-related information depends on whether the fourth node decides on Quality of Experience measurement configuration or not: if the fourth node decides on Quality of Experience measurement configuration, the eighth configuration-related information may include at least one of the following: a request for Quality of Experience measurement configuration or a request for application layer measurement configuration, information related to suggested/recommended configuration for Quality of Experience measurement or suggested/recommended configuration for application layer measurement, parameter(s) related to Quality of Experience measurement or application layer measurement; if it is not the fourth node that decides to do (e.g., the fourth node only confirms) the Quality of Experience measurement configuration, at least the configuration information related to Quality of Experience measurement or application layer measurement may be included in the eighth configuration related information.

It is further worth mentioning that one possible way of transmitting the resource allocation mode is that the third node decides the resource allocation mode and indicates the resource allocation mode to the fourth node by including the resource allocation mode in the ninth information.

Wherein the Quality of Experience measurement configuration or the application layer measurement configuration or the suggested/recommended Quality of Experience measurement configuration or the suggested/recommended application layer measurement configuration at least includes, but is not limited to, one of the following information:
Quality of Experience reference or Quality of Experience reference identity
Area scope related information or location filter related information
Address of the measurement collection entity
Slice list or slice identity
Reporting interval or reporting period/periodicity
Measurement time-related information

Wherein the area scope related information or location filter related information includes at least one of:
Cell identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Cell-Radio Network Temporary Identifier (C-RNTI) or other Radio Network Temporary Identifier
gNB distribution unit user equipment F1 Interface application layer protocol identity (gNB-DU UE F1AP ID)

Wherein the information related to the identity of the receiving user equipment/RX UE comprises at least one of:
Sidelink destination identity/ID
Sidelink destination identity/ID list
Application layer group identity/ID
Application layer group identity/ID list
Cell Radio Network Temporary Identity or other Radio Network Temporary Identity
Cell Radio Network Temporary Identity list or other Radio Network Temporary Identity list
gNB distribution unit user equipment F1 Interface application layer protocol identity
gNB list of distribution unit user equipment F1 Interface application layer protocol identity

The ninth information may be included in an F1AP UE CONTEXT SETUP REQUEST message, in an F1AP UE CONTEXT MODIFICATION REQUEST message, in an F1AP UE CONTEXT MODIFICATION CONFIRM message, or in other F1AP messages.

The fourth node, after receiving the ninth information, according to the content of the ninth information, performs Quality of Experience measurement configuration acknowledgement/confirm or application layer measurement configuration acknowledgement/confirm and transmits a message comprising the Quality of Experience measurement configuration acknowledgement/confirm or application layer measurement configuration acknowledgement/confirm information to the third node, or provides the Quality of Experience measurement configuration or application layer measurement configuration and transmits the Quality of Experience measurement configuration or application layer measurement configuration to the third node. The third node may provide one or more Quality of Experience measurement configuration or one or more request for the measurement configuration to the fourth node, each of which may be uniquely identified/acknowledged/confirmed by a measurement identity or reference identity in the ninth information, wherein the measurement identity may comprise at least one of a configuration identity for Quality of Experience measurement or application layer measurement, a configuration identity for sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity. The fourth node generates a resource allocation configuration according to the received resource allocation mode.

In the manner described above in which the third node provides a Quality of Experience measurement configuration or a request for the measurement configuration to the fourth node, it is guaranteed that the fourth node can obtain the Quality of Experience measurement configuration in time and obtain the Quality of Experience measurement report according to the configuration-related information (if it is not the fourth node that decides on the Quality of Experience measurement configuration), or that the fourth node, according to the request of the third node, can provide the Quality of Experience measurement configuration to the third node in time (if the fourth node decides on the Quality of Experience measurement configuration), and thus it is guaranteed that the second node performs the corresponding Quality of Experience measurement and/or reporting, thereby guaranteeing that the fourth node and/or the third node can make a more flexible allocation of resources based on the Quality of Experience measurement, thereby improving the Quality of Experience of the user. In addition, by way of the third node deciding the resource allocation mode and indicating it to the fourth node, it is guaranteed that the fourth node can provide a more reasonable resource allocation configuration, thereby ensuring that the resource allocation optimization or scheduling optimization proceeds smoothly.

The fourth node transmits, to the third node, tenth information related to measurement configuration of the sidelink-related Quality of Experience, wherein the tenth information includes ninth configuration-related information for the sidelink-related Quality of Experience measurement.

It is worth mentioning that the fourth node may transmit the tenth information based on the received ninth information, or may be directly triggered/initiated to transmit the tenth information.

Wherein the ninth configuration-related information of the sidelink-related Quality of Experience measurement comprises at least one of the following:
Service type information related to Proximity Service (ProSe) or V2X (Vehicle-to-Everything) traffic
Information related to Quality of Experience measurement configuration or application layer measurement configuration
Information related to suggested/recommended configuration for Quality of Experience measurement or suggested/recommended configuration for application layer measurement
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Information related to an identity of the transmitting user equipment/TX UE
Information related to an identity of the receiving user equipment/RX UE
Resource allocation mode(s)

Please be noted that the content of the ninth configuration-related information depends on whether or not the fourth node decides to perform configuration for Quality of Experience measurement: if the fourth node decides to perform configuration for Quality of Experience measurement, the ninth configuration-related information includes at least configuration information related to Quality of Experience measurement or application layer measurement; if it is not the fourth node that decides to do (e.g., the fourth node only participates in) the Quality of Experience measurement configuration, then at least the information related to suggested/ recommended configuration for Quality of Experience measurement or suggested/ recommended configuration for application layer measurement is included in the ninth configuration-related information.

It is further worth mentioning that one possible way to transmit the resource allocation mode is that the fourth node decides the resource allocation mode and transmits the resource allocation mode and/or resource allocation mode-related configuration to the third node through the tenth information.

Wherein the Quality of Experience measurement configuration or the application layer measurement configuration or the suggested/recommended Quality of Experience measurement configuration or the suggested/recommended application layer measurement configuration at least includes, but is not limited to, one of the following information:
Quality of Experience reference or Quality of Experience reference identity
Area scope related information or location filter related information
Measurement collection entity address
Slice list or slice identity
Reporting interval or reporting period/periodicity
Measurement time-related information

Wherein the area scope related information or location filter related information includes at least one of:
Cell Identity or cell list
Tracking Area Code (TAC) or Tracking Area List
Tracking Area Identity or Tracking Area Identity list
PLMN Identity or PLMN List

Wherein the measurement time-related information includes at least one of:
Measurement start time
Measurement end time
Measurement duration
Measurement time window

Wherein the information related to the identity of the transmitting user equipment/TX UE comprises at least one of:
Sidelink source identity/ID
Sidelink source identity/ID list
Application layer group identity/ID
Application layer group identity/ID list
Cell-Radio Network Temporary Identifier (C-RNTI) or other Radio Network Temporary Identifier
Cell Radio Network Temporary Identity list or other Radio Network Temporary Identity list
gNB Centralized Unit User Equipment F1 Interface Application Layer Protocol Identity (gNB-CU UE F1AP ID)
gNB Centralized Unit User Equipment F1 Interface Application Layer Protocol Identity list

Wherein the information related to the identity of the receiving user equipment/RX UE comprises at least one of:
Sidelink destination identity/ID
Sidelink destination identity/ID list
Application layer group identity/ID
Application layer group identity/ID list
Cell Radio Network Temporary Identity or other Radio Network Temporary Identity
Cell Radio Network Temporary Identity list or other Radio Network Temporary Identity list
gNB Centralized Unit User Equipment F1 Interface Application Layer Protocol Identity
gNB Centralized Unit User Equipment F1 Interface Application Layer Protocol Identity list

The tenth information may be included in an F1AP UE CONTEXT SETUP RESPONSE message, in an F1AP UE CONTEXT MODIFICATION RESPONSE message, in an F1AP UE CONTEXT MODIFICATION REQUIRED message, or in other F1AP messages.

If after receiving the tenth information, according to the content of the tenth information, the third node performs Quality of Experience measurement configuration acknowledgement/confirm or application layer measurement configuration acknowledgement/confirm, or provides Quality of Experience measurement configuration or application layer measurement configuration and transmits the Quality of Experience measurement configuration or application layer measurement configuration to the fourth node. The fourth node may provide to the third node one or more Quality of Experience measurement configuration or suggested/recommended Quality of Experience measurement configuration, each of which may be uniquely acknowledged by a measurement identity or reference identity in the tenth information, wherein the measurement identity may comprise at least one of a configuration identity for Quality of Experience measurement or application layer measurement, a configuration identity for sidelink Quality of Experience measurement or sidelink application layer measurement, and a configuration identity for Quality of Experience measurement of PC5 interface or application layer measurement of the PC5 interface; and wherein the reference identity may comprise a Quality of Experience reference or Quality of Experience reference identity.

By providing the Quality of Experience measurement configuration or suggested/ recommended Quality of Experience measurement configuration to the third node as described above, the third node is guaranteed to obtain the Quality of Experience measurement configuration in time and provide it to the first node or the second node (if the fourth node decides to do the Quality of Experience measurement configuration), and the second node is guaranteed to perform the corresponding Quality of Experience measurement and/or reporting, thereby guaranteeing that the fourth node and/or the third node can make a more flexible allocation of resources based on the Quality of Experience measurement, thereby improving the Quality of Experience of the user.

FIG. 3F illustrates an example method for measurement configuration and reporting of sidelink-related quality-of-experience, according to another embodiment of the present disclosure. As shown in FIG. 3F, the first node or the second node transmits eleventh information for reporting the sidelink-related Quality of Experience measurement to the third node or the fourth node, wherein the eleventh information includes second report related information for the sidelink-related Quality of Experience measurement.

It is further worth mentioning that the eleventh information may also be forwarded or transmitted to a fourth node if it is the third node that receives the eleventh information.

Wherein the second report related information comprising the sidelink-related Quality of Experience measurement comprises at least one of:
Configuration identity for Quality of Experience measurement or application layer measurement
Configuration identity for sidelink Quality of Experience measurement or sidelink application layer measurement
Configuration identity for Quality of Experience measurement of PC5 interface or application layer measurement of the PC5 interface
Sidelink destination identity/ID
Information related to an identity of the transmitting user equipment/TX UE
Quality of Experience measurement results or Quality of Experience measurement report(s)

Wherein the information related to the identity of the transmitting user equipment/TX UE comprises at least one of:
Sidelink source identity/ID
Sidelink source identity/ID list
Application layer group identity/ID
Application layer group identity/ID list
Cell Radio Network Temporary Identity or other Radio Network Temporary Identity
Cell Radio Network Temporary Identity list or other Radio Network Temporary Identity list

The eleventh information may be included in a measurement report message, in a measurement report app layer message, in other RRC messages, or in a MAC Control Element (MAC CE).

After the fourth node receives the eleventh information, the fourth node performs resource allocation or scheduling to the first node or the second node according to the content of the eleventh information. The third node or the fourth node determines, from the measurement configuration identity, a Quality of Experience measurement configuration for which the eleventh information is subject to. The third node or the fourth node identifies the second node according to the sidelink destination identity/ID. The third node or the fourth node identifies the first node according to the information related to the identity of the transmitting user equipment/TX UE. Wherein the measurement identity may comprise at least one of: a configuration identity of Quality of Experience measurement or application layer measurement, a configuration identity of sidelink Quality of Experience measurement or sidelink application layer measurement, and a configuration identity for Quality of Experience measurement of PC5 interface or application layer measurement of the PC5 interface.

By the manner in which the first node or the second node reports the Quality of Experience measurement to the third node or the fourth node as described above, it is ensured that the third node or the fourth node can correctly identify the Quality of Experience measurement report and that the fourth node makes a more flexible allocation of resources based on the Quality of Experience measurement report, thereby improving the Quality of Experience of the user.

FIG. 3G illustrates an example method for measurement configuration and/or reporting of sidelink-related quality-of-experience, according to another embodiment of the present disclosure. The third node or the fourth node receives the eleventh information from the first node or the second node, and then, the third node or the fourth node decides or suggests data for the first node to preferentially schedule or preferentially allocate resources to the second node according to the content in the eleventh information, and transmits the twelfth information to the first node as shown in FIG. 3G, and further, the twelfth information may include information related to the identity of the second node and priority related information. Further, the priority related information may include at least one of the following information: indication or suggested/recommended indication related to prioritized scheduling or prioritized allocation of resources; an indication or suggested/recommended indication related to low-priority/de-prioritized scheduling or low-priority/de-prioritized allocation resource; and priority. In a more specific embodiment, the twelfth information includes at least one of the following information:
Indication related to prioritized scheduling or prioritized allocation of resources to a designated PC5 communication link
Indication related to low priority scheduling or low priority allocation of resources to a designated PC5 communication link
Indication related to suggesting prioritized scheduling or prioritized allocation of resources to a designated PC5 communication link
Indication related to suggesting low priority scheduling or low priority allocation of resources to a designated PC5 communication link
Priority related information of the PC5 communication link
Identity related information of the receiving user equipment/RX UE in the PC5 communication link or in a designated PC5 communication link

Wherein the identity related information of the receiving user equipment/RX UE in the PC5 communication link or in the designated PC5 communication link comprises at least one of:
Sidelink destination identity/ID
Sidelink destination identity/ID list
Application layer group identity/ID
Application layer group identity/ID list

In one embodiment, the twelfth information is transmitted based on Quality of Experience information received by the fourth node from the third node.

The twelfth information may be included in the RRC Reconfiguration (RRCReconfiguration) message, in other RRC messages, in MAC control elements, or in other Downlink Control Information (DCI).

After receiving the twelfth information, the first node performs corresponding scheduling or resource allocation according to the content of the twelfth information. The first node receives the identity related information of the user equipment via the PC5 communication link or a designated PC5 communication link confirming the receiving user equipment/RX UE that needs scheduling or resource allocation adjustment accordingly.

By the manner in which the third node or the fourth node transmits the PC5 communication link related resource allocation or scheduling information to the first node or the second node as described above, it is ensured that the first node can correctly identify the receiving user equipment/RX UE that needs scheduling or resource allocation adjustments and make correct scheduling or resource allocation adjustments to the corresponding receiving user equipment/RX UE, thereby improving the Quality of Experience of the user.

FIG. 3H illustrates an example method for measurement configuration and/or reporting of sidelink-related quality-of-experience, according to another embodiment of the present disclosure. As shown in FIG. 3H, the fifth node transmits thirteenth information for indicating the traffic-related information to the third node, wherein the thirteenth information includes at least one of the following information:
Service type information related to Proximity Service (ProSe) or V2X (Vehicle-to-Everything) traffic
Quality of Experience related authorization information for Proximity Traffic or V2X service

Wherein the Quality of Experience related authorization information of the proximity service or V2X service at least includes one of the following function:
Authorizing the user equipment to use Quality-of-Experience-related functionality
Authorizing the user equipment to use Quality-of-Experience-related functions as a transmitting user equipment/TX UE
Authorizing the user equipment to use a Quality of Experience-related function as a receiving user equipment/RX UE

The thirteenth information may be included in an NGAP INITIAL CONTEXT SETUP REQUEST message, in an NGAP UE CONTEXT MODIFICATION REQUEST message, in an NGAP HANDOVER REQUEST message, in an NGAP PATH SWITCH REQUEST ACKNOWLEDGE/CONFIRM message, or in other NGAP messages.

After receiving the thirteenth information, the third node confirms whether the corresponding user equipment is authorized to use the Quality of Experience-related function according to the Quality of Experience-related authorization information of the proximity service or V2X service. The third node decides to accept or reject the request for Quality of Experience measurement configuration or configuration from other nodes according to the Quality of Experience related authorization information of the proximity service or V2X service.

Further, the third node transmits seventh information to the first node or the second node based on the received thirteenth information, wherein the seventh information comprises at least one of:
Service type information related to ProSe or V2X service;
A request for Quality of Experience measurement configuration or a request for application layer measurement configuration;
Information related to suggested/recommended configuration for Quality of Experience measurement or suggested/recommended configuration for application layer measurement;
Parameter(s) related to Quality of Experience measuremen or an application layer measurement;
A configuration identity for Quality of Experience measurement or application layer measurement or list of configuration identities/IDs;
Information related to identity of the second node; and
Resource allocation mode(s).

By the way in which the third node receives information indicating service related information as described above, it is ensured that the third node can correctly identify user equipment(s) that are authorized to use Quality of Experience related functions, thereby ensuring that only authorized user equipment(s) can participate in Quality of Experience configuration, measurement or reporting.

FIG. 3I illustrates an example flowchart one of measurement configuration and reporting for sidelink in a wireless communication system.

In FIG. 3I, step 0: the first node establishes PC5 direct communication with the second node, this process may require participation of the third node and the fifth node;
Step 1: the first node transmits a message of sidelink user equipment information to the third node in which the fifth information is included;
Step 2: the fifth node transmits a user equipment context modification request message to the third node in which the thirteenth information is included;
Step 3: the third node decides that the second node performs Quality of Experience measurement on traffic from the first node;
Step 4: the third node transmits a user equipment context modification request message to the fourth node in which the ninth information is included;
Step 5: the fourth node transmits a user equipment context modification response message to the third node in which the tenth information is included;
Step 6: the third node transmits a RRCReconfiguration message to the second node in which the sixth information is included;
Step 7: the second node transmits a RRCReconfigurationSidelink message to the first node in which the third information is included;
Step 8: the first node transmits a RRCReconfigurationCompleteSidelink message to the second node in which the fourth information is included;
Step 9: the second node performs Quality of Experience measurement;
Step 10: the second node transmits an application layer measurement report message to the third node in which the eleventh information is included;
Step 11: the third node transmits a Quality of Experience information transfer message to the fourth node;
Step 12: the fourth node decides for the first node to prioritize scheduling or prioritize allocation of resources to the data of the second node;
Step 13: the fourth node transmits downlink control information or MAC control element to the first node in which the twelfth information is included;
Step 14: the first node prioritizes scheduling or prioritizes allocation of resources to the data of the second node;
Step 15: the first node transmits sidelink control information to the second node including the resources allocated to the second node.

It is noted that FIG. 3I mainly considers the case in which the base station centralized and distributed units are separated, if the case in which the base station is not separated is considered (i.e. the case in which the third node is a base station), then steps 4, 5 and 11 of FIG. 3I are no longer needed, step 12 becomes being performed by the third node, step 13 becomes the third node transmitting the twelfth information to the first node, and the remaining steps remain unchanged. The twelfth information may also be transmitted through downlink control information or MAC control element.

FIG. 3J illustrates an example flowchart two of measurement configuration and reporting for sidelink in a wireless communication system.

In FIG. 3J, step 0: the first node establishes PC5 direct communication with the second node, this process may require involvement of a third node;
Step 1: the first node decides to let the second node perform Quality of Experience measurement;
Step 2: the first node transmits a message of sidelink user equipment information to the third node in which the fifth information is included;
Step 3: the third node transmits a user equipment context modification request message to the fourth node in which the ninth information is included;
Step 4: the fourth node transmits a user equipment context modification response message to the third node in which the tenth information is included;
Step 5: the third node transmits a RRCReconfiguration message to the first node in which the seventh information is included;
Step 6: the first node transmits a RRCReconfigurationSidelink message to the second node in which the first information is included;
Step 7: the second node transmits a RRCReconfigurationCompleteSidelink to the first node;
Step 8: the second node transmits a RRCReconfigurationComplete message to the third node in which the eighth information is included;
Step 9: the second node performs Quality of Experience measurement;
Step 10: the second node transmits a sidelink measurement report message to the first node in which the second information is included;
Step 11: the first node transmits an application layer measurement report message to the third node in which the eleventh information is included;
Step 12: the third node suggests the first node to prioritize scheduling or prioritize allocation of resources to data of the second node;
Step 13: the third node transmits a RRCReconfiguration message to the first node in which the twelfth information is included;
Step 14: the first node prioritizes scheduling or prioritizes allocation of resources to the data of the second node;
Step 15: the first node transmits sidelink control information to the second node including the resources allocated to the second node.

It is noted that FIG. 3J mainly considers the case in which the base station centralized and distributed units are separated, and if the case in which the base station is not separated is considered (i.e. the case in which the third node is a base station), steps 3 and 4 in FIG. 3J are no longer needed and the remaining steps remain unchanged.

FIG. 3K illustrates an example three of measurement configuration and reporting for sidelink.

In FIG. 3K, step 0: the first node establishes PC5 direct communication with the second node, this process may require involvement of the third node and/or the fifth node;
Step 1: the first node and the second node transmit a message of sidelink user equipment information to the third node in which the fifth information is included;
Step 2: the fifth node transmits a user equipment context modification request message to the third node in which the thirteenth information is included;
Step 3: the third node transmits a RRCReconfiguration message to the first node in which the seventh information is included;
Step 4: the first node transmits a RRCReconfigurationSidelink message to the second node in which the first information is included;
Step 5: the second node transmits a RRCReconfigurationCompleteSidelink message to the first node;
Step 6: the second node transmits a RRCReconfigurationComplete message to the third node, which possibly includes the eighth information;
Step 7: the second node performs Quality of Experience measurement;
Step 8: the second node transmits to the first node a sidelink measurement report message including the above-mentioned second information in which the second information comprises first report related information of sidelink-related Quality of Experience measurement;
Step 9: the first node transmits an application layer measurement report message to the third node in which the eleventh information is included;
Step 10: the third node transmits a Quality of Experience information transfer message to the fourth node;
Step 11: the fourth node decides for the first node to prioritize scheduling or prioritize allocation of resources to the data of the second node;
Step 12: the fourth node transmits a MAC control element or downlink control information to the first node in which the twelfth information is included;
Step 13: the first node prioritizes scheduling or allocation of resources to the data of the second node;
Step 14: the first node transmits sidelink control information to the second node including the resources allocated to the second node.

It is worth mentioning that steps 9-12 may or may not exist depending on the resource allocation mode.

It is further noted that FIG. 3K mainly considers the case in which base station centralized and distributed units are separated, and if the case in which the base station is not separated is considered (i.e. the case in which the third node is a base station), then step 10 in FIG. 3K is no longer needed, step 11 becomes being performed by the third node, step 12 becomes the third node transmitting the twelfth information to the first node, and the remaining steps remain unchanged. Wherein the twelfth information can also be transmitted through MAC control unit or downlink control information FIG. 4 is a block diagram of the first node or the second node according to the present invention.

Referring to FIG. 4, the first node or the second node according to the present disclosure may be a user equipment, which may include a transceiver 410, a processor 420, wherein the transceiver 410 is coupled with the processor 420. Optionally, the network node may further comprise a memory 430. The transceiver 410, processor 420, and memory 430 are configured to perform the operations of the methods and/or embodiments of the disclosure. Although transceiver 410, processor 420, and memory 430 are shown as separate entities, they may be implemented as a single entity, such as a single chip. Also, the processor 420 may include a controller or at least one processor. Furthermore, the UE of FIG. 4 corresponds to the UE 201 of FIG. 1.

The transceiver 410, processor 420, and memory 430 may be electrically connected or coupled to each other. The transceiver 410 collectively refers to a UE receiver and a UE transmitter. The transceiver 410 may transmit and receive signals to and from other network nodes, e.g., other UEs, a base station, or a core network device (e.g., AMF), etc.. The signal transmitted or received to or from the base station or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor 420, a signal through a wireless channel, and transmit a signal output from the processor 420 through the wireless channel.

The memory 430 may store a program and data required for operations of the UE. Also, the memory 430 may store control information or data included in a signal obtained by the UE. The memory 430 may be a storage medium, such as read-only memory (ROM), random access memory (RAM), a hard disk, a CD-ROM, and a DVD, or a combination of storage media. The memory 430 may store instructions for implementing an operation and/or functionality of one of the above-described embodiments.

The processor 420 may include one or more processing units and may control the UE to perform an operation and/or function according to one of the above-described embodiments. The processor 420 may control a series of processes such that the UE operates as described above. For example, the transceiver 410 may receive a data signal including a control signal transmitted by the base station or the network entity, and the processor 420 may determine a result of receiving the control signal and the data signal transmitted by the base station or the network entity.

A method performed by the first node in a wireless communication system includes receiving twelfth information from a base station, the twelfth information including information related to an identity of a second node and priority related information; and based on the received priority related information, performing corresponding scheduling or resource allocation on the second node.

In a further embodiment, the priority related information comprises at least one of: indication or suggested/recommended indication related to prioritized scheduling or prioritized allocation of resources; indication or suggested/recommended indication related to low-priority/de-prioritized scheduled or low-priority/de-prioritized allocated resources; and priority.

In a further embodiment, the method further comprises transmitting first configuration-related information to a second node, the first configuration-related information being related to sidelink-related Quality of Experience measurement, wherein the first configuration-related information comprises at least one of: service type information related to the ProSe or V2X service; configuration information related to Quality of Experience measurement or application layer measurement; information related to configuration identity for Quality of Experience measurement or application layer measurement; and a resource allocation mode.

In further embodiments, the information related to the Quality of Experience measurement configuration or application layer measurement configuration comprises at least one of: a Quality of Experience reference; area scope related information or location filter related information; a measurement collection entity address; a slice list or slice identity; a reporting interval or reporting period/periodicity; and measurement time-related information.

In further embodiments, the area scope related information or location filter related information comprises at least one of: a cell identity or a cell list; a tracking area code (TAC) or tracking area list; a tracking area identity or a list of tracking area identities/IDs; and a public land mobile network (PLMN) identity or PLMN list.

In further embodiments, the measurement time related information comprises at least one of: measurement start time; measurement end time; measurement duration; and a measurement time window.

In further embodiments, the method further comprises: transmitting fifth information to the base station, wherein the fifth information comprises information related to an identity of the user equipment; wherein the information related to an identity of the user equipment comprises at least one of: information for indicating the first node or the second node; information related to the identity of the first node; and information related to the identity of the second node.

In further embodiments, the information related to an identity of the first node comprises at least one of: a sidelink source identity/ID or a list of sidelink source identities/IDs; and an application layer group identity/ID or a list of the group identities/IDs.

In further embodiments, the information related to the identity of the second node comprises at least one of: a sidelink destination identity/ID or a list of destination identities/IDs; and an application layer group identity/ID or a list of the group identities/IDs.

In further embodiments, the method further comprises receiving seventh information from the base station, the seventh information comprising at least one of: service type information related to the ProSe or V2X service; a request for Quality of Experience measurement configuration or a request for application layer measurement configuration; information related to suggested/recommended configuration for Quality of Experience measurement or suggested/recommended configuration for application layer measurement; parameter(s) related to Quality of Experience measurement or application layer measurement; a configuration identity for Quality of Experience measurement, application layer measurement or list of those configuration identities/IDs; information related to the identity of the second node; and a resource allocation mode.

In further embodiments, the seventh information is transmitted by the base station based on thirteenth information it receives, wherein the thirteenth information comprises at least one of: service type information related to ProSe or V2X service; and authorization information related to Quality of Experience for the ProSe or V2X service.

In further embodiments, the authorization information related to Quality of Experience for the ProSe or V2X service comprises at least one of functions: authorizing the user equipment to use Quality of Experience-related functions; authorizing the user equipment to use Quality of Experience-related functions as a transmitting user equipment/TX UE; and authorizing the user equipment to use the Quality of Experience-related function as a receiving user equipment/RX UE.

In a further embodiment, the method further comprises receiving first report related information from a second node, the first report related information comprising a sidelink-related Quality of Experience measurement report; transmitting second report related information to the base station through a RRC message or a medium access control (MAC) control unit.

FIG. 5 is a block diagram of a network node in a network according to the present disclosure.

A network node in the network may be used to implement the third node, the fourth node, or the fifth node, etc. in the present invention. Referring to FIG. 5, the network node according to the present disclosure comprises a transceiver 510, a processor 520, wherein the transceiver 510 is coupled with the processor 520. Optionally, the network node may further comprise a memory 530. The transceiver 510, the processor 520, and the memory 530 are configured to perform the operations of the methods and/or embodiments of the invention. Although transceiver 510, processor 520, and memory 530 are shown as separate entities, they may be implemented as a single entity, such as a single chip. Also, the processor 520 may include a controller or at least one processor. Furthermore, the BS of FIG. 5 corresponds to the NG-RAN 202 of FIG. 1.

The transceiver 510, the processor 520, and the memory 530 may be electrically connected or coupled to each other. The transceiver 510 collectively refers to a base station receiver and a base station transmitter. The transceiver 510 may transmit and receive signals to and from other network nodes, such as a UE, other base station, a part of a base station or a core network device (e.g., an AMF), or the like. The signal transmitted or received to or from the terminal or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 520, a signal through a wireless channel, and transmit a signal output from the processor 520 through the wireless channel.

The memory 530 may store a program and data required for operations of the base station. Also, the memory 530 may store control information or data included in a signal obtained by the base station. The memory 530 may be a storage medium, such as read-only memory (ROM), random access memory (RAM), a hard disk, a CD-ROM, and a DVD, or a combination of storage media.

The memory 530 may store instructions for implementing an operation and/or functionality of one of the embodiments described above.

The processor 520 may include one or more processing units and may control the network node to perform operations and/or functions according to one of the above-described embodiments. The processor 520 may control a series of processes such that the base station operates as described above. For example, the transceiver 510 may receive a data signal including a control signal transmitted by the terminal, and the processor 520 may determine a result of receiving the control signal and the data signal transmitted by the terminal.

A method performed by a third node in a wireless communication network includes receiving second report related information from the first node or the second node; and transmitting twelfth information to the first node, the twelfth information including information related to the identity of the second node and priority related information.

In a further embodiment, the priority related information comprises at least one of: an indication or suggested/recommended indication related to prioritized scheduling or prioritized allocation of resources; an indication or suggested/recommended indication related to low-priority/de-prioritized scheduling or low-priority/de-prioritized allocation resource; and priority.

In further embodiments, the method further comprises: receiving fifth information from the first node or the second node, wherein the fifth information comprises information related to an identity of the user equipment; wherein the information related to the identity of the user equipment comprises at least one of: information for indicating the first node or the second node; information related to an identity of the first node; information related to an identity of the second node.

In further embodiments, the information related to the identity of the first node comprises at least one of: a sidelink source identity/ID or a list of sidelink source identities/IDs; and an application layer group identity/ID or a list of the group identities/IDs.

In further embodiments, the information related to the identity of the second node comprises at least one of: a sidelink destination identity/ID or a list of destination identities/IDs; and an application layer group identity/ID or a list of the group identities/IDs.

In further embodiments, the method further comprises: transmitting seventh information to the first node or the second node, the seventh information comprising at least one of: service type information related to the ProSe or V2X service; a request for Quality of Experience measurement configuration or a request for application layer measurement configuration; information related to suggested/recommended configuration for Quality of Experience measurement or suggested/recommended configuration for application layer measurement; parameter(s) related to Quality of Experience measurement or application layer measurement; a configuration identity for Quality of Experience measurement, application layer measurement or list of those configuration identities/IDs; information related to an identity of the second node; and a resource allocation mode.

In a further embodiment, the method further comprises receiving thirteenth information from a fifth node, the thirteenth information comprising at least one of: service type information related to ProSe or V2X service; and authorization information related to Quality of Experience for the ProSe or V2X service.

In further embodiments, the authorization information related to Quality of Experience for the ProSe or V2X service comprises at least one of functions: authorizing the user equipment to use Quality of Experience-related functions; authorizing the user equipment to use Quality of Experience-related functions as a transmitting user equipment/TX UE; and authorizing the user equipment to use the Quality of Experience-related function as a receiving user equipment/RX UE.

In further embodiments, the method further comprises receiving seventh configuration-related information from the first node or the second node, the sidelink seventh configuration-related information comprising at least one of: service type information related to the ProSe or V2X service; configuration information related to Quality of Experience measurement or application layer measurement; configuration identity for Quality of Experience measurement or application layer measurement information; information related to the identity of the first node; and a resource allocation mode.

In a further embodiment, when the seventh configuration-related information is received from the second node, the seventh configuration-related information is transmitted by the second node based on the first configuration-related information received from the first node.

According to another aspect of the disclosure, there is provided a method performed by the fourth node in a wireless communication network, the method comprising: receiving Quality of Experience information from the third node; and transmitting twelfth information to the first node, the twelfth information including information related to the identity of the second node and priority related information. In a further embodiment, the priority related information comprises at least one of: an indication or suggested/recommended indication related to prioritized scheduling or prioritized allocation of resources; an indication or suggested/recommended indication related to low-priority/de-prioritized scheduling or low-priority/de-prioritized allocation resource; and priority. In a further embodiment, the method further comprises receiving eighth configuration-related information from a third node, wherein the eighth configuration-related information includes at least one of: service type information related to proximity traffic or V2X service; a request for Quality of Experience measurement configuration or a request for application layer measurement configuration; information related to suggested/recommended configuration for Quality of Experience measurement or suggested/recommended configuration for application layer measurement; parameter(s) related to Quality of Experience measurement or application layer measurement; a configuration identity of Quality of Experience measurement or application layer measurement; and transmitting information related to an identity of the user equipment; and transmitting ninth configuration-related information to the third node, wherein the ninth configuration-related information includes at least one of: configuration or configuration related information for Quality of Experience measurement or application layer measurement; a configuration identity of Quality of Experience measurement or application layer measurement; and transmitting the information related to the identity of the user equipment.

According to an embodiment of the present disclosure, there may further be provided a computer-readable storage medium storing instructions, which, when executed by at least one processor, cause the at least one processor to perform any one of the above-described methods according to exemplary embodiments of the present disclosure. Examples of the computer readable storage medium herein include read-only memory (ROM), random-access programmable read-only memory (PROM), electrically erasable programmable read-only memory (EEPROM), random-access memory (RAM), dynamic random-access memory (DRAM), static random-access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid state hard disk (SSD), card memory (such as multimedia card, secure digital (SD) card, or extreme digital (XD) card), magnetic tape, floppy disk, magneto and any other decice, which is configured to store the computer program and any associated data, data files and data structures in a non-transitory manner and to provide the computer program and any associated data, data files and data structures to the processor or computer so that the processor or computer can execute the computer program. The instructions in the computer-readable storage media described above or the computer program may be executed in an environment deployed in a computer device such as a client, host, agent apparatus, server, etc.. Furthermore, in one example, the computer program and any associated data, data files, and data structures are distributed over a networked computer system so that the computer program and any associated data, data files, and data structures are stored, accessed, and executed in a distributed fashion by one or more processors or computers.

Those of skill in the art will appreciate that the above illustrative embodiments are described herein and are not intended to be limiting. It should be understood that any two or more of the embodiments disclosed herein may be combined in any combination. Further, other embodiments may be utilized, and other changes may be made, without departing from the spirit and scope of the subject matter presented herein. It will be readily understood that the aspects of the invention of the present disclosure, as generally described herein, and illustrated in the figures, can be arranged, substituted, combined, separated, and designed in a wide variety of different configuration, all of which are contemplated herein.

Those of skill in the art will appreciate that the various illustrative logical blocks, modules, circuits, and steps described herein may be implemented as hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such design decisions should not be interpreted as causing a departure from the scope of the present application.

The various illustrative logical blocks, modules, and circuits described herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, a removable disk, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage medium may be any available medium that can be accessed by a general purpose or special purpose computer.

The foregoing is merely an exemplary implementation of the present application and is not intended to limit the protection scope of the present application, which is defined by the following claims.

1. A method performed by a first node in a wireless communication system, the method comprising:
receiving twelfth information from a base station, wherein the twelfth information comprises information related to an identity of a second node and priority related information; and
based on the received priority related information, performing corresponding scheduling or resource allocation on the second node.

2. The method of claim 1, wherein the priority related information comprises at least one of:
indication or a related suggested or recommended indication related to prioritized scheduling or prioritized allocation of resources;
indication or suggested or recommended indication related to low-priority/de-prioritized scheduling or low-priority or de-prioritized allocation of resources; or
priority.

3. The method of claim 1, further comprising:
transmitting first configuration-related information to the second node, the first configuration-related information being related to sidelink-related Quality of Experience measurement, and
wherein the first configuration-related information comprises at least one of:
service type information related to proximity service (ProSe) or vehicle-to-everything (V2X) service;
configuration information related to Quality of Experience measurement or application layer measurement;
information related to configuration identity for Quality of Experience measurement or application layer measurement; or
a resource allocation mode.

4. The method of claim 1, further comprising:
transmitting fifth information to the base station, wherein the fifth information comprises information related to an identity of a terminal; and
wherein the information related to the identity of the terminal comprises at least one of:
information for indicating the first node or the second node;
information related to an identity of the first node;
information related to the identity of the second node.

5. The method of claim 4, wherein the information related to the identity of the first node comprises at least one of:
a sidelink source identity (ID) or a list of sidelink source IDs; or
an application layer group ID or a list of the group IDs.

6. The method according to claim 4, wherein the information related to the identity of the second node comprises at least one of:
a sidelink destination ID or a list of sidelink destination IDs; or
an application layer group ID or a list of the group IDs.

7. The method of claim 1, further comprising:
receiving seventh information from the base station, wherein the seventh information comprises at least one of:
service type information related to the ProSe or V2X service;
a request for Quality of Experience measurement configuration or a request for application layer measurement configuration;
Information related to suggested or recommended configuration for Quality of Experience measurement or suggested or recommended configuration for application layer measurement;
parameters related to Quality of Experience measurement or application layer measurement;
a configuration identity for Quality of Experience measurement, application layer measurement or list of those configuration IDs;
information related to the identity of the second node; or a resource allocation mode.

8. The method of claim 7, wherein the seventh information is transmitted by the base station based on thirteenth information, wherein the thirteenth information comprises at least one of:
service type information related to the ProSe or V2X service; or
Quality of Experience related authorization information for the ProSe or V2X service.

9. A method performed by a third node in a wireless communication system, the method comprising:
receiving second report related information from a first node or a second node; and
transmitting twelfth information to the first node, the twelfth information comprising information related to an identity of the second node and priority related information.

10. The method of claim 9, wherein the priority related information comprises at least one of:
prioritized scheduling or prioritized allocation of resources related indication or related recommendation indication;
an indication or suggested or recommended indication related to low-priority or de-prioritized scheduling or low-priority or de-prioritized allocation resource; or
priority.

11. The method of claim 9, further comprising:
receiving fifth information from the first node or the second node, wherein the fifth information comprises information related to an identity of the terminal; and
wherein the information related to the identity of the terminal comprises at least one of:
information for indicating the first node or the second node;
information related to an identity of the first node; or
information related to the identity of the second node.

12. The method of claim 9, further comprising:
transmitting seventh information to the first node or the second node, wherein the seventh information comprises at least one of:
service type information related to the ProSe or V2X service;
a request for Quality of Experience measurement configuration or a request for application layer measurement configuration;
information related to suggested/recommended configuration for Quality of Experience measurement or suggested/recommended configuration for application layer measurement;
parameters related to Quality of Experience measurement or application layer measurement;
a configuration identity for Quality of Experience measurement, application layer measurement or list of those configuration IDs;
information related to an identity of the second node; or a resource allocation mode.

13. The method of claim 9, further comprising:
receiving thirteenth information from a fifth node, wherein the thirteenth information comprises at least one of:
service type information related to the ProSe or V2X service; or
Quality of Experience related authorization information for the ProSe or V2X service.

14. The method of claim 9, further comprising:
receiving seventh configuration-related information from the first node or the second node, wherein the seventh configuration-related information comprises at least one of:
service type information related to the ProSe or V2X service;
configuration information related to Quality of Experience measurement or application layer measurement;
information related to configuration identity for Quality of Experience measurement or application layer measurement;
information related to an identity of the first node; or a resource allocation mode.

15. The method of claim 14, wherein when the seventh configuration-related information is received from the second node, the seventh configuration-related information is transmitted by the second node based on the first configuration-related information received from the first node.
